(19) United States
(12) Patent Application Publication
(10) Pub. No.: US 2023/0105885 A1
(43) Pub. Date: Apr. 6, 2023

(54) System and Method for Learning User Preferences

(71) Applicant: Acxiom LLC, Conway, AR (US)

(72) Inventor: Thomas Lawrence Shrum, Conway, AR (US)

(21) Appl. No.: 17/860,968

(22) Filed: Jul. 8, 2022

Related U.S. Application Data
(60) Provisional application No. 63/252,372, filed on Oct. 5, 2021.
(60) Provisional application No. 63/252,374, filed on Oct. 5, 2021.

(51) Int. Cl. G10L 15/07; G06F 3/16; G10L 15/22; G10L 15/30; G06F 16/65; G06F 16/27

(52) U.S. Cl. CPC G10L 15/07; G06F 3/167; G10L 15/22; G10L 15/30; G06F 16/65; G06F 16/273; G10L 2015/228; G06F 9/453

(57) ABSTRACT

A system and method for learning user preferences operates by posing topics in a manner similar to a human-to-human conversation. The system learns which topics to present to a human user from an initially seeded response database containing natural language phrases. The system then records user responses into the same response database or a connected response database. The system assigns user responses into categories, such as positive, negative, request for information, null, and potentially others. The system then bases future topics on what it learns during the interaction, including user responses, user response categories, time of data, location, how busy the human user typically is at difference times of day or certain days, and the like.

### CROSS-REFERENCE TO RELATED APPLICATIONS

This application claims priority to U.S. Provisional Patent Application Nos. 63/252,372 and 63/252,374, each filed on Oct. 5, 2022. Each of these provisional applications is hereby incorporated by reference in its entirety.

### BACKGROUND

Digital assistants, in their more simplistic form often referred to as “chatbots,” are computer programs that simulate a conversation with a human user, typically over the Internet. The various digital assistant systems may use machine learning, artificial intelligence, and natural language processing to provide a more natural simulated conversation with a user. These are often used to answer questions, such as when a user is engaging with an e-commerce website and has questions about a particular product or service.

Digital assistants may use historical information, such as past purchases, preferences, demographic information, and such to create data models that improve their interaction with the human user. In this way, they may answer more complex questions, provide recommendations even about matters not directly raised by the human user, and make predictions. Examples of well-known digital assistants include the Apple Siri and Amazon Alexa services, which can answer many general questions from a human user.

A weakness of existing digital assistants is that they are not particularly effective at learning user preferences. The inventor hereof has recognized that this weakness of these technologies stems from the fact that they do not initiate conversations in the way that humans do, and thus could be improved by creating a system and method that learns a human user's preferences by posing topics, much in the same way that two humans who do not know each other well often interact during a conversation in order to get to know each other better.

### SUMMARY

The invention is directed to a system and method for learning a human user's preferences by posing topics in a manner similar to a human-to-human conversation. In certain embodiments, the system learns which topics to present from an initially seeded response database containing natural language phrases. The system then records user responses into the same response database or a connected response database. The system assigns user responses into categories, such as positive, negative, request for information, null, and potentially others. The system then bases future topics on what it learns during the interaction, including user responses, user response categories, time of data, location, how busy the human user typically is at difference times of day or certain days, and the like.

One aspect of the invention in certain embodiments is that it initiates communications with a human user, and thus it does not require a method to determine whether it is being addressed as typical digital assistants do.

### DRAWINGS

FIG. 1 illustrates a system for implementing a system for learning user preferences, according to certain embodiments of the present invention.

FIG. 2 is a flow chart illustrating a method for learning user preferences using the system of FIG. 1, according to certain embodiments of the present invention.

FIG. 3 is a system schematic for a computer system to implement the system of FIG. 1 in order to perform the method of FIG. 2, according to certain embodiments of the present invention.

The Figures described above are a representative set and are not exhaustive with respect to embodying the invention.

### DESCRIPTION

Disclosed is a system and method for learning user preferences. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment, or according to some embodiments. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagram included herein is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can be an application specific computing interface to facilitate cross-network communications to extend the functionality of a software application.

Artificial intelligence (AI) is the intelligence demonstrated by machines rather than natural humans, and includes the ability of a computer, using a combination of hardware and software, to perform tasks such as but not limited to communication tasks, that are typically though of as tasks performed by humans rather than machines. AI may be implemented through a wide variety of methods and algorithms.

Cloud computing can be the on-demand availability of computer system resources, especially data storage and computing power, without direct active management by the end user.

Machine learning (ML) is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, among other things, decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g., random decision forests) are an ensemble learning method for classification, regression, and other tasks, that operate by constructing a multitude of decision trees at training time and outputting the class that is the mode of the classes (e.g., classification) or mean prediction (e.g., regression) of the individual trees. RFs can correct for decision trees' habit of overfitting to their training set. Deep learning is a family of machine learning methods based on learning data representations. Learning can be supervised, semi-supervised or unsupervised.

User refers to a real-world human user. Such person may be a customer, patient, software user, etc. depending upon various applications of certain embodiments of the present invention as described herein.

Example Methods and Systems

In the embodiments described herein, the present invention learns a person's preferences by posing topics, much as a human friend would in a casual human-to-human conversation. It learns which topics to present from an initially seeded response database containing natural language phrases. This database may be constructed partially or wholly from interactions with other human users. The system records user responses into the same response database or a separate, although linked, response database. In various embodiments, any number of such databases may be constructed and linked. The system assigns user responses into positive, negative, request for information, null, and other user response categories. It bases future topics on what it learns (e.g., user responses, user response categories, time of day, location, how busy the user typically is at certain times on certain days, etc.). It may be seen then that the invention does not need to rely on prompts, such as “Hey Siri” for the Apple Siri digital assistant, because it initiates conversations with the human user rather than waiting to be addressed by the human user.

In a particular example, the response database may be initially seeded with topic phrases akin to “Are you hungry?”, “Are you thirsty?”, “Are we going shopping?”, etc. Positive user responses to the topic phrases may be “Sure”, “I am hungry”, “This is nice”, “Thank you”, “That's a good idea”, etc. Negative user responses may be “Are you kidding?”, “Shut up!”, “I can't believe you're suggesting that”, “Not now”, “I'm busy”, “Quiet!”, etc. Request for information user responses may be “Where should I eat?”, “What's close that has good chicken?”, “Where can I get a good jacket cheap?”, etc. User response categories may be food, drink, shopping, never say this again, say this more often, positive, negative, close out, etc.

Certain embodiments of the invention are instantiated via an application on a phone, a tablet, a laptop, or other personal computing device (device) having both a microphone and a speaker. The device provides a user response to its dedicated aural processor. The aural processor accesses learning software installed upon the device which compares user responses to responses contained within the response database on the device. The learning software selects the most appropriate phrase in the response database corresponding to the user response and plays that phrase through the device speaker.

In certain embodiments, the aural processor is a hardware chip that contain one or more processing cores in a single multiprocessor and uses memory from the device on which it is installed. The aural processor chip may be device agnostic, taking analog auditory input and sending analog auditory output. The aural processor chip contains firmware to digitize and textualize input for comparison of data within the response database and to create an analog output from text within the response database. The aural processor uses commercially available methods to account for regional accent (e.g., Northeastern vs. Southern) and similar phrasing (e.g., “I would like that” vs. “I'd like that”, etc.) and selects the most appropriate phrase from the response database. The aural processor may employ artificial intelligence techniques, including machine learning techniques as one example.

Device-specific (e.g., phone, tablet, laptop, desktop, etc.) learning software is responsible for creating a user-friendly experience through selection of an appropriate phrase from the response database, storage of new user responses in the response database, categorization of user responses within the response database, and prioritization of phrases within the response database. Appropriate phrases may be selected based upon response category, time of day, location, and user response. User responses to the selected phrase may be deemed “new” if not found in the user response database. User responses may be categorized based upon similarity with other user responses within a given category. Phrases may be prioritized higher or lower depending upon positive or negative user responses, respectively.

After conversations are concluded, the device response database synchronizes with a shared device response database located in the cloud to provide a single user response reference regardless of device. Response database synchronization occurs asynchronously and bi-directionally. The device response database(s) synchronize with the cloud response database while the cloud response database synchronizes responses from other devices with the primary device.

In alternative embodiments, any part of the components as described herein may be implemented using hardware, software, or a combination of hardware and software. For example, the aural processor as previously described may be implemented partially or wholly in software, and may also be implemented as firmware on a more general-purpose hardware chip that is programmable, such as a field-programmable gate array (FPGA) chip.

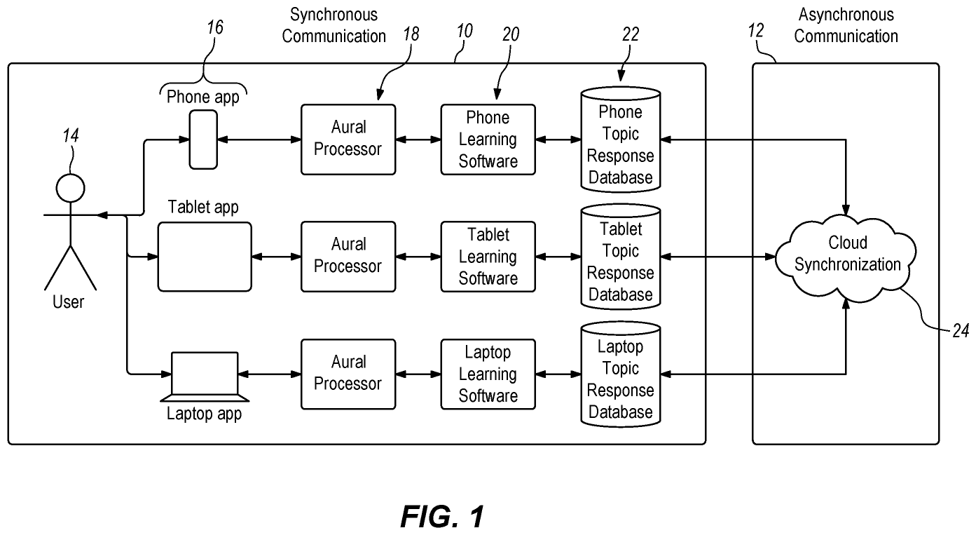

Referring now to FIG. 1, a system to implement the certain embodiments just described may be illustrated in greater detail. The system is divided into two regions, the synchronous communication region 10 and the asynchronous communication region 12. Synchronous communication takes place as the system is in use by the human user in conversation mode. Asynchronous communication is used after the conversation is complete in order to perform remote cloud synchronization. This remote synchronization takes place asynchronously by communication between the synchronous communication region 10 and the asynchronous communication region 12 across a network, such as the Internet.

User 14 may interact with the system using the software application or app 16. In FIG. 1, three examples are provided of a smartphone app, an electronic tablet app, and a laptop app, although the invention is not limited by these variations of app 16. Any software on an electronic device that allows for input/output with user 14 may be used to host app 16.

App 16 communicates with aural processor 18 as previously described. Aural processor receives analog auditory input from user 14 through app 16, such as spoken language as the portion of the conversation maintained by user 14. Aural processor 16 outputs analog auditory information as well.

The output of aural processor 18 is sent to learning software 20, which communicates with response database 22. As with app 16, learning software 20 and response database 22 may take many forms depending upon the hardware used to host learning software 20 and response database 22. FIG. 1 illustrates learning software 20 and response data base 22 hosted on a smartphone, an a tablet, and a laptop, although the invention is not so limited.

Cloud synchronization 24 is the process by which synchronization is performed with response database 22 when user 14 is not actively using the system, such as after a conversation with user 14 has concluded. Cloud synchronization 24 may be performed on third-party hosted cloud computing and storage hardware, such as Microsoft Azure or Amazon Web Service (AWS). Alternatively, cloud synchronization 24 may be performed on dedicated hardware systems. Cloud synchronization may be performed through an interface at cloud synchronization 24, which may include an application programming interface (API).

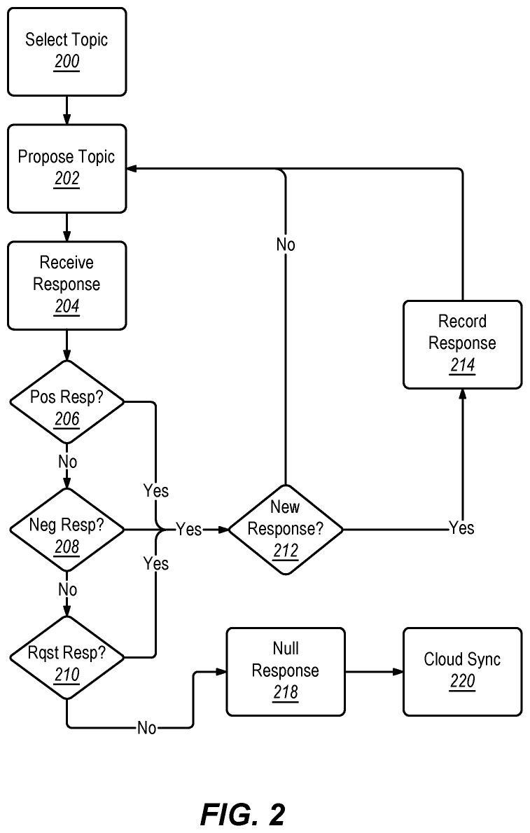

Referring now to FIG. 2, the process of employing the system of FIG. 1 in order to discover user 14's preferences may be described in more detail. The process begins at select topic step 200, at which the system selects a topic of conversation for an interaction with user 14. The topic is selected from topic response database 22. The topic is proposed to user 14 at propose topic step 202, using aural processor 18 to communicate the topic in natural language to user 14 by way of app 16. The user responds, which is received through aural processor 18 in the reverse manner at receive response 204.

Once the user 14 response is received, the system then determines through learning software 20 which type of response has been received. If may be determined to be a positive response at positive response query step 206, a negative response at negative response query step 208, or a request for information response at request response query step 210. In any of these cases, after the type of response has been determined, the system at learning software 20 then determines whether the response is a new response (i.e., one that has not been previously received) at new response query step 212. If the response is a new response, then it is added to topic response database 22 at record response step 214. In either case, processing then returns to propose topic step 202 in order to move the conversation to the next topic/response.

If neither a positive, negative, or request for information response is received, then the system in this embodiment records a null response at null response step 218. In that case, the conversation comes to an end. The system then performs cloud synchronization 24 asynchronously at a later time, at cloud synchronization step 220.

Example Device Architecture and Systems

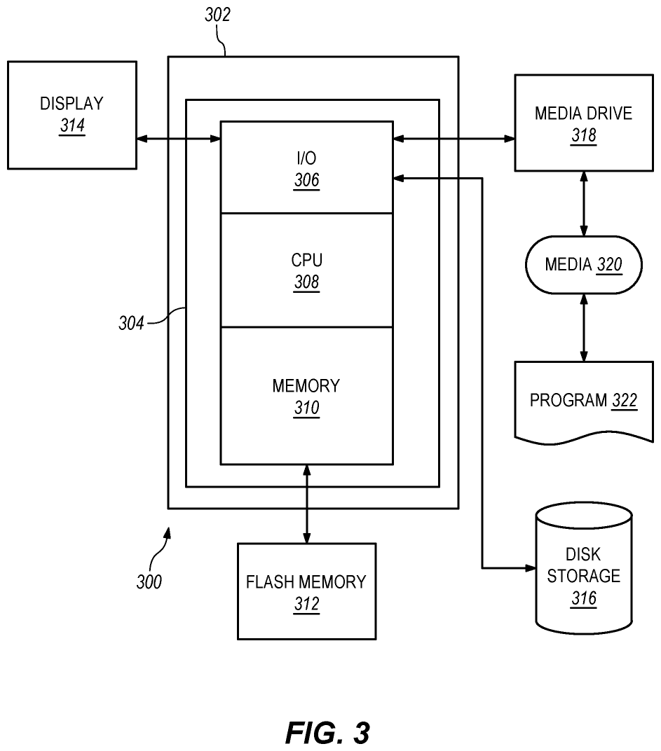

FIG. 3 depicts an exemplary computing system 300 that can be configured to perform any one of the processes provided herein. In this context, computing system 300 may include, for example, a processor, memory, storage, and I/O devices (e.g., monitor, screen, keyboard, touchscreen, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

The main system 302 includes a motherboard 304 having an I/O section 306, one or more central processing units (CPUs) or processors 308, and a memory section 310, which may have a flash memory card 312 related to it. The CPU 308 may be a multiprocessor system. The I/O section 306 can be connected to a display 314, a keyboard and/or other user input (not shown), a disk storage unit 33, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such as Wi-Fi, Bluetooth® (and/or other standards for exchanging data over short distances including those using short-wavelength radio transmissions), USB, Ethernet, cellular, etc. Computing system 300 may be implemented as a local system or a cloud-based system, in the latter case operating potentially as a virtual computing system within a cloud-computing environment.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computerized method for learning user preferences, the method comprising:
retrieving from a response database a first proposed topic;
at an aural processor, constructing a first auditory message comprising the first proposed topic;
at an app executing at a user device, outputting the first auditory message;
at the app at the user device, receiving an auditory response message, wherein the auditory response message comprises a user response to the first proposed topic;
at the aural processor, processing the auditory response message to retrieve a user response;
recording the user response in the response database;
assigning the user response into a response category chosen from one of a plurality of response categories;
selecting a second proposed topic at least in part based on the response category assigned to the user response;
at the aural processor, constructing a second auditory message comprising the second proposed topic; and
at the app at the user device, outputting the second auditory message.

2. The method of claim 1, wherein the plurality of response categories comprises a positive response and a negative response.

3. The method of claim 2, wherein the plurality of response categories further comprises a request for information response.

4. The method of claim 3, wherein the plurality of response categories further comprises a null response.

5. The method of claim 4, wherein the steps of outputting the first auditory message, receiving an auditory response message, processing the auditory response message, recording the user response in the response database, and assigning the user response into a response category are repeated until the user response is a null response.

6. The method of claim 1, wherein the first proposed topic and the second proposed topic each comprise a natural language phrase.

7. The method of claim 1, wherein the step of selecting a second proposed topic is based at least in part on a time of day at which the response message is received.

8. The method of claim 1, wherein the step of selecting a second proposed topic is based at least in part on a location of the user device when the response message is received.

9. The method of claim 1, further comprising the step of synchronizing the response database with a remote cloud database across a network.

10. The method of claim 9, wherein the step of synchronizing the response database is performed asynchronously.

11. A system for learning user preferences, comprising:
an aural processor;
a response database;
one or more computer processors; and
a memory space having instructions stored therein, the instructions, when executed by the one or more computer processors, causing the one or more computer processors to perform operations comprising:
retrieving from the response database a first proposed topic;
at the aural processor, constructing a first auditory message comprising the first proposed topic;
at an app executing at a user device, outputting the first auditory message;
at the app at the user device, receiving an auditory response message, wherein the auditory response message comprises a user response to the first proposed topic;
at the aural processor, processing the auditory response message to retrieve a user response;
recording the user response in the response database;
assigning the user response into a response category chosen from one of a plurality of response categories;
selecting a second proposed topic at least in part based on the response category assigned to the user response;
at the aural processor, constructing a second auditory message comprising the second proposed topic; and
at the app at the user device, outputting the second auditory message.

12. The system of claim 11, wherein the plurality of response categories comprises a positive response, a negative response, a request for information response, and a null response.

13. The system of claim 12, wherein the instructions, when executed by the one or more computer processors, further cause the one or more computer processors to perform operations comprising the steps of outputting the first auditory message, receiving an auditory response message, processing the auditory response message, recording the user response in the response database, and assigning the user response into a response category repeatedly until the user response is a null response.

14. The system of claim 11, wherein the first proposed topic and the second proposed topic each comprise a natural language phrase.

15. The system of claim 11, wherein the step of selecting a second proposed topic is based at least in part on a time of day at which the response message is received.

16. The method of claim 11, wherein the step of selecting a second proposed topic is based at least in part on a location of the user device when the response message is received.

17. The method of claim 11, wherein the instructions, when executed by the one or more computer processors, further cause the one or more computer processors to perform operations comprising the step of synchronizing the response database with a remote cloud database across a network.

18. The method of claim 17, wherein the instructions, when executed by the one or more computer processors, further cause the step of synchronizing the response database to be performed asynchronously.

19. A system for learning preferences, comprising:
a server comprising at least one computer processor;
a response database in communication with the server, wherein the response database comprises a plurality of topics; and
an aural processor in communication with the server, wherein the aural processor is configured to convert a topic into an auditory message and further configured to convert an auditory response to a user response,
wherein the server is configured to retrieve from the response database a topic and transmit the retrieved topic to the aural processor, and to receive from the aural processor a user response and store the user response in the response database.

20. The system of claim 19, further comprising a user device comprising an app, wherein the app is configured to receive from the aural processor the auditory message and play the auditory message for the user and to receive the auditory response from the user and transmit the auditory response to the aural processor.

21. The system of claim 20, further comprising a cloud database connected to the response database across a network, wherein the server is further configured to asynchronously synchronize the response database with the cloud database.
